(19) United States
(12) Patent Application Publication
(10) Pub. No.: US 2007/0169900 A1
(43) Pub. Date: Jul. 26, 2007

(54) Rolling up curtain device

(76) Inventors: Ju-Chang Chen, Taipei City (TW); Yen-Kun Shen, Sanchong City (TW)

Correspondence Address: Dykema Gossett, PLLC, Suite 300 West, 1300 I Street, N.W., Washington, DC, 20005-3306, US

(21) Appl. No.: 11/337,970

(22) Filed: Jan. 24, 2006

(51) Int. Cl. E06B 9/56

(52) U.S. Cl. 160/321

(57) ABSTRACT

The present invention provides an improved rolling up curtain device comprises a fixed device, a driving device, a cover, a resistant device and a rolling device. The improved rolling up curtain device of the present invention is located at a right hand side of a curtain so that it can reduce its occupied space. The rolling up curtain device, which is convenient and easy to use is compact to install. The improved structure of the rolling up curtain device requires less fabrication cost.

### BACKGROUND OF THE INVENTION

1. Field of Invention

The present invention relates to a structure of rolling up curtain device. More particularly, the present invention relates to a curtain that can be rolled up to maximize its space utilization and reduce its fabrication cost on materials and production process.

2. Description of the Related Art

In order to accommodate crowed population, a lot of skyscrapers are built in the big city. However, those skyscrapers normally have large windows that are enormous in sizes require specially made curtains to cover them up so that people occupied the space can have some privacy in the rooms or can protect from the sunlight. Those curtains would require a special device that can roll up the curtains easily.

The conventional rolling up curtain devices comprises a rolling up device that is normally installed at a top portion of the curtain, wherein a user would pull a rope of the device to drive the rolling device so that the curtain could be either rolled up directly onto the rolling device or the curtain would be folded up and the rope would be rolled up onto the rolling device. The conventional rolling device is covered up by a cover of the curtain. In other words, the conventional rolling up device is installed inside the top portion of the curtain. This kind of design requires space, materials cost and production cost. Furthermore, since this design requires to incorporate with the curtain, when the length of the curtain is increased, the rolling up device will be increased in length, or its width to accommodate the various sizes of curtain. Therefore, the occupied space, the material costs and the manufacturing cost of the prior art rolling up device would be increased as well. It is, therefore, an object of present invention to provide an improved rolling up curtain device that can overcome those disadvantages.

### SUMMARY OF THE INVENTION

It is an object of the present invention to provide an improved rolling up curtain device can occupy less space. The improved rolling up device of the present invention is located at a right hand side of a curtain so that it can reduce its occupied space.

It is another object of the present invention to provide an improved rolling up curtain device which is convenient and easy to use is compact in size.

It is another object of the present invention to provide an improved structure of the rolling up curtain device that requires less fabrication cost.

The present invention provides an improved rolling up curtain device comprising a fixed device that can support and locate the improved rolling up curtain device. The improved rolling up curtain device further comprises a driving device having a driving shaft wherein the driving shaft is assembled to the fixed device, and its position is approximately perpendicular to a surface area of a curtain. A resistant device is slipped onto the driving shaft and a protruding portion of the fixed device in order to restrict rotational movement of the driving shaft. A rolling device comprises at least one trench surrounded a circumference of the rolling device, wherein the driving shaft drives the rolling device to rotate around a central point of the driving shaft, and a guiding rope is rolled up around the trench of the rolling device.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a 3-D assembly view of an improved rolling up curtain device in accordance with a preferred example of the present invention;

FIG. 2 is a 3-D view of an assembled improved rolling up curtain device in accordance with the preferred example of the present invention;

FIG. 3 illustrates a cross-sectional view of the improved rolling up curtain device in accordance with the preferred example of the present invention;

FIG. 4 shows a 3-D view of the improved rolling up curtain device assembled with a curtain in accordance with a preferred example of the present invention;

FIG. 5 illustrates a cross-sectional view of showing a curtain of the improved rolling up curtain device being pulled up in an upward direction in accordance with a preferred example of the present invention;

FIG. 6 is a cross-sectional view of showing how the improved rolling up curtain device being stop in a desired position in accordance with a preferred example of the present invention;

FIG. 7 is a cross-sectional view of showing how the improved rivaling up curtain device being unblocked in a desired position in accordance with a preferred example of the present invention.

### DESCRIPTION OF THE PREFERRED EMBODIMENTS

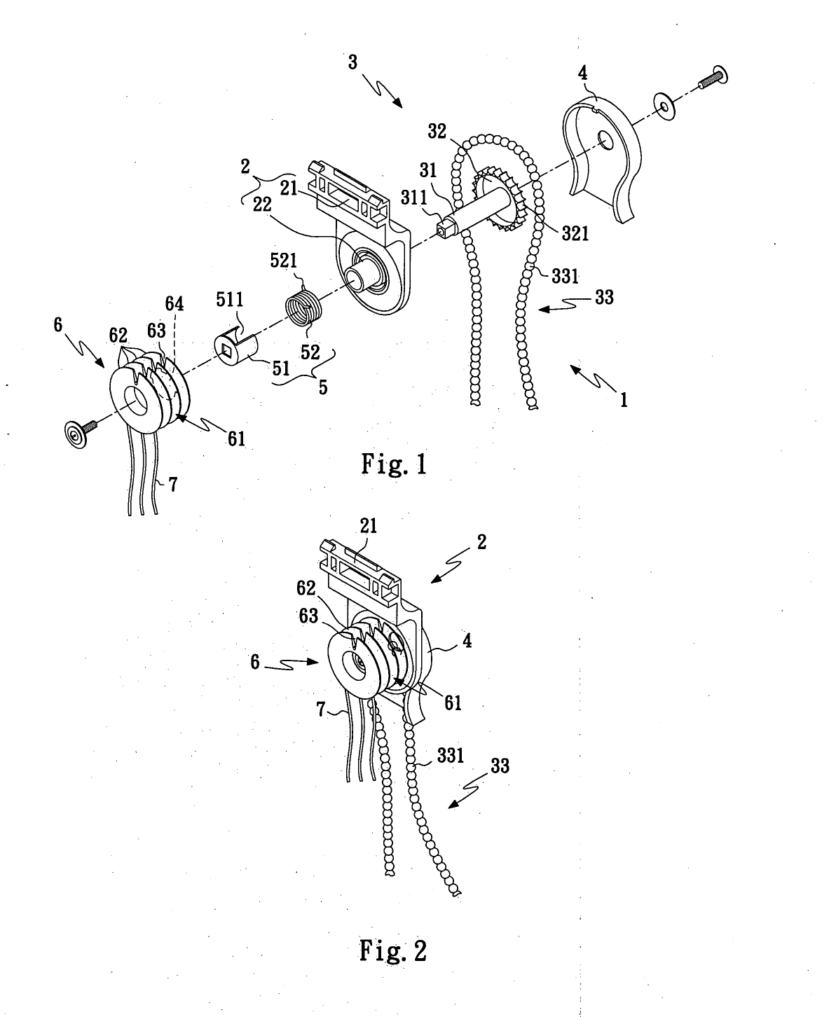

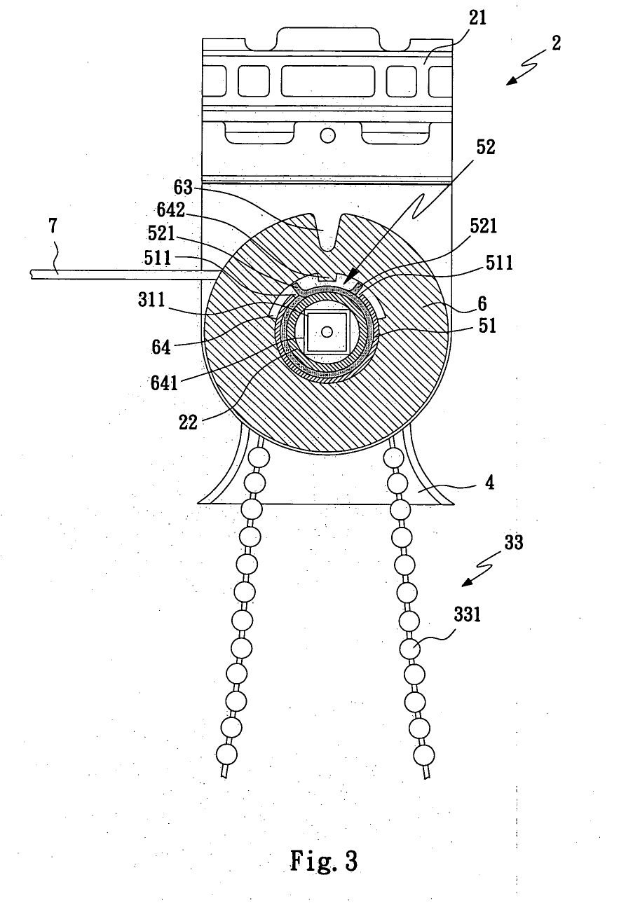

FIGS. 1, 2 and 3 show schematic views of an improved rolling up curtain in accordance with a preferred example of the present invention. The improved rolling up curtain device 1 of the present invention comprises a fixed device 2, a driving device 3, a cover 4, a resistant device 5 and a rolling device 6.

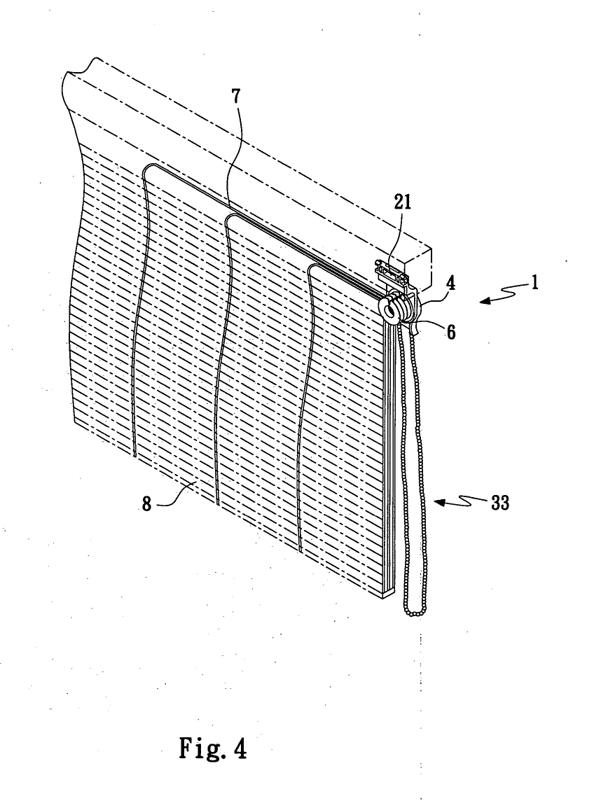

The main purpose of the fixed device 2 is to support and fix those components of the improved rolling up curtain device 1 in place. The fixed device 2 comprises a fixed portion 21 and a protruding portion 22 used to locate the resistant device 5. On the other hand, the driving device 3 comprises a driving shaft 31, a driving gear 32 and a driving chain 33, wherein the driving gear 32 consists of a plurality of gear slots 321, and the driving chain 33 comprises a plurality of beads 331. The driving chain 33 is hanged onto the driving gear 32, and the driving shaft 31 is located within the fixed device 2 and the protruding portion 22. A driving section 311 is formed on one end of the driving shaft 31, wherein the driving section 311 of the driving shaft 31 is utilized to drive the resistant device 5 and the rolling device 6. The driving shaft 31 is positioned at a central part of the driving gear 32 in such that a central point of the driving shaft 31 is coincided with a central, point of the driving gear 32. Another end of the driving, shaft 31 is perpendicularly to a back surface of the driving gear 32 and does not protrude through the back surface of the driving gear 32. The position of the driving shalt 31 and a curtain 8 (refer to FIG. 4) is perpendicular to each other approximately The cover 4 is located onto the fixed device 2.

The resistant device 5 comprises a sleeve 51 and an anti-elastic unit 52, wherein the sleeve 51 comprises a cavity 51, and a stop unit 521 is formed respectively on both ends of the anti-elastic unit 52. The anti-elastic unit 52 is slipped onto the protruding portion 22 of the fixed device 2. The sleeve 51 is put around the anti-elastic unit 52, and the two stop units 521 are located within the cavity 51 of the sleeve 51. The sleeve 51 is then assembled onto the driving section 311 of the driving shaft 31.

The rolling device 6 comprises at least one trench 61 surrounded the rolling device 6 and a plurality of rolling discs, wherein the driving shaft 31 drives the rolling device along the central point of the driving shaft 31. A guiding rope 7 is rolled up around the trench 61 of the rolling device 6, and a small slot 63 is formed on a top portion of every rolling disc 62. One end of the guiding rope 7 is tightly wedged between a space of the small slot 63. The rolling device 6 further comprises a trench opening 64, wherein the trench opening 64 is located inside the rolling device 6 and comprises a hole 641 formed on a top part of the trench opening 64. A stop block 642 is formed at a circumference of the trench opening 64, and its width size is smaller than a width between a gap of two stop units 521 of the anti-elastic unit 52. The sleeve 51 is slipped into the trench opening 64, wherein the stop block 642 is positioned in between the gap of the two stop units 521 of the anti-elastic unit 52. The hole 641 is slipped through the driving section 311 of the driving shaft 31, wherein a shape of a cross-sectional area of the hole 641 is conformed with a shape of a cross-sectional area of the driving section 311. However, a rotating angle or a rolling angle of the driving section 311 inside the hole 641 is less than 180 degrees.

FIG. 4 is 3-D view of the improved rolling up curtain device set up with a curtain in accordance with a preferred example of the present invention. The rolling up curtain device 1 is located at a right hand side of the curtain as shown in FIG. 4. From the diagrams, it is clear that the present invention provides an improved rolling up curtain device which is small in size is convenient to use. The improved structure of the rolling up curtain device 1 requires less space, easy to use, and its fabrication cost is reduced.

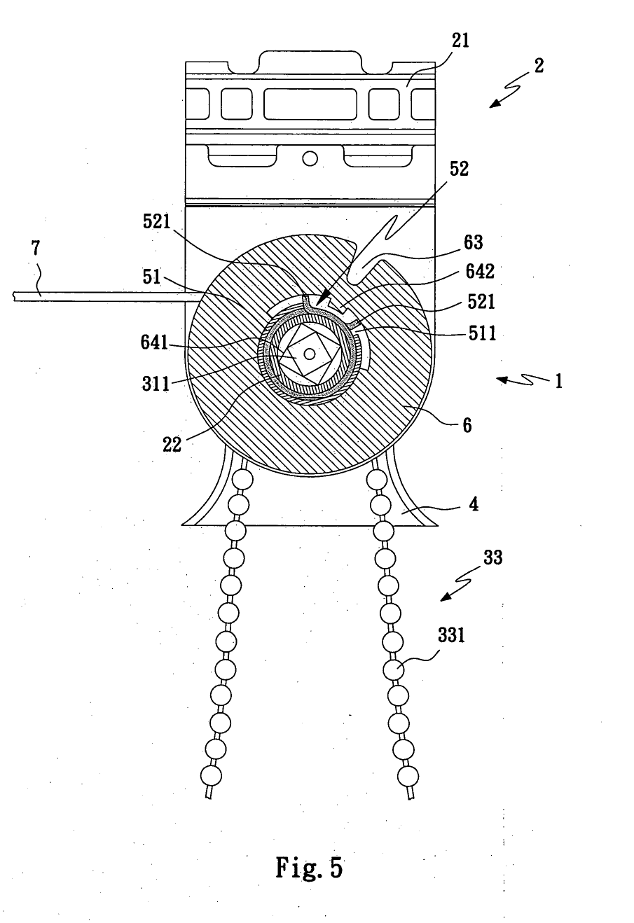

FIG. 5 illustrates a schematic view of having a curtain of the improved rolling up curtain device being pulled up in an upward direction in accordance with a preferred example of the present invention. When a curtain 8 is pulled in the upward direction, the driving chain 33 drives along with the driving gear 32 in such that the driving section 311 of the driving shaft 31 is driven in a rotational movement. However, the driving section 311 cannot rotate freely inside the hole 641, in fact, its movement will be blocked inside the hole 641 in order to drive the guiding rope 7 of the rolling device 6 to roll up the curtain 8.

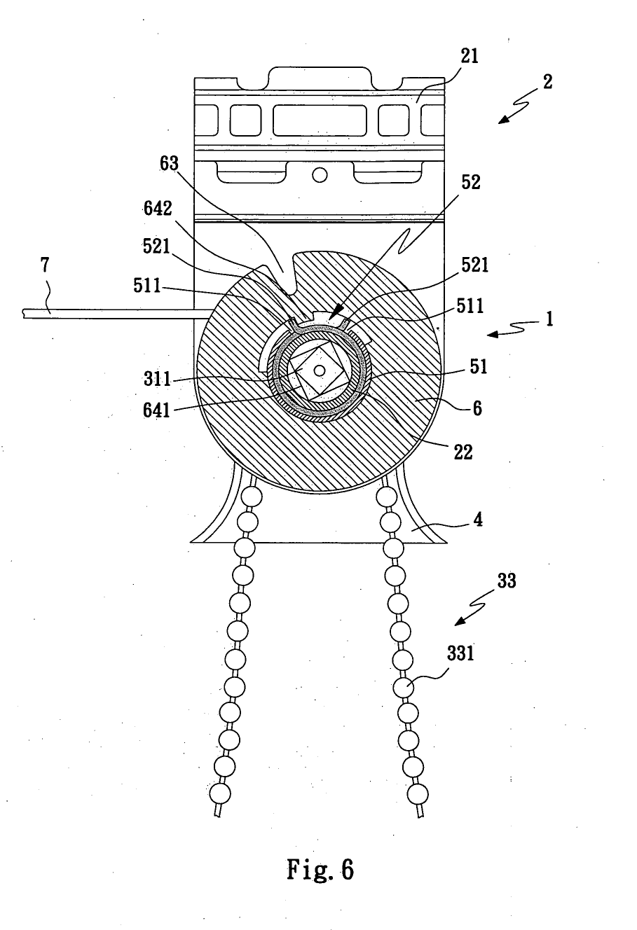

FIG. 6 is a schematic view of showing how the improved rolling up curtain device being stop in a desired position in accordance with a preferred example of the present invention. Once the curtain 8 is rolled up in a desired position, the weight of the curtain 8 is carried by the rolling up curtain device 1, wherein the weight of the curtain 8 will be transferred to the stop block 642 of the rolling device 6 in such that the stop unit 521 of the anti-elastic unit 52 will be suppressed by the weight of the curtain 8. The weight of the curtain 8 will be then transferred from the stop unit 521 to the protruding portion 22 of the fixed device 2 so that the rolling up curtain device 1 comprises an anti-slippery function. Therefore, the curtain 8 can be located at a desired position without sliding down due to its own weight.

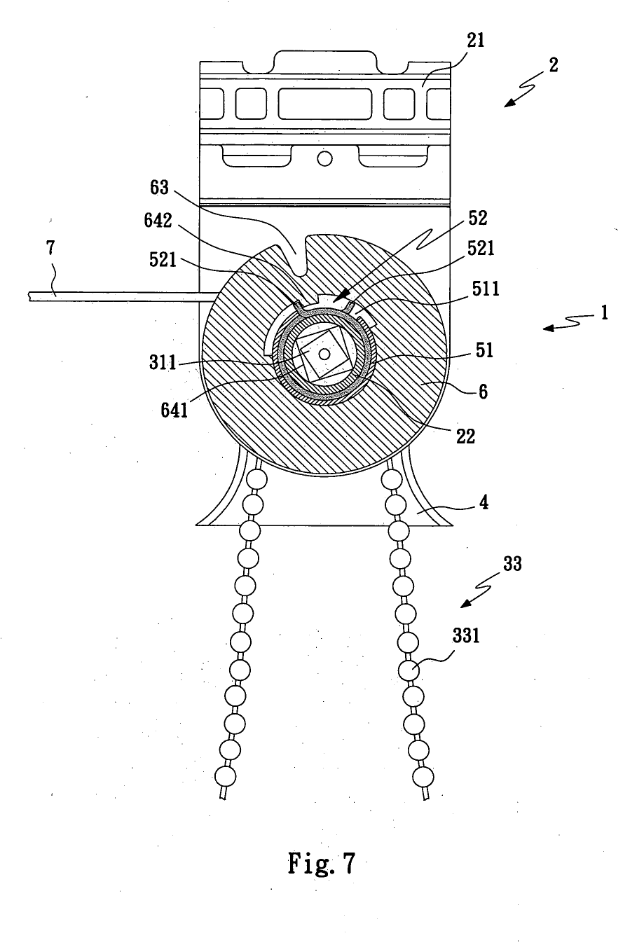

FIG. 7 is a schematic view of showing how the improved rolling, up curtain device being unblocked in a desired position in accordance with a preferred example of the present invention. When a user would like to roll up or roll down the curtain again, the driving chain 33 will drive along with the driving gear 32 in such that the driving section 311 of the driving shaft 31 will be driven in a rotational movement. The driving section 311 will drive the sleeve 51 in such that the sleeve 51 will move along one side of the cavity 511 in order to unblock the stop unit 521 of the anti-elastic unit 52 so that the protruding portion 22 of the fixed device 2 can be driven. The driving section 311 of the driving shaft 31 will then drive the hole 641 of the rolling device 6 to cause the rotational movement.

It is clear from the above-mentioned invention, the present invention provides an improved rolling up curtain device that is located at a right hand side of the curtain as shown to reduce its occupied space. The rolling up-curtain device of the present invention is small in size and compact to install. Furthermore, the rolling up curtain device is convenient and easy to use. The improved structure of the rolling up curtain device requires less fabrication cost.

Other embodiments of the invention will appear to those skill in the art from consideration of the specification and practice of the invention disclosed herein It is intended that the specification and examples to be considered as exemplary only, with a true scope and spirit of the invention being indicated by the following claims.

What is claimed is:

1. An improved rolling up curtain device, comprising
a fixed device, supporting and locating the improved rolling up curtain device;
a driving device, having a driving shaft, wherein the driving shaft is assembled to the fixed device, and its position is approximately perpendicular to a surface area of a curtain;
a resistant device, slipping onto the driving shaft and a protruding portion of the fixed device in order to restrict rotational movement of the driving shaft; and
a rolling device, having at least one trench surrounded a circumference of the rolling device, wherein the driving shaft drives the rolling device to rotate around a central point of the driving shaft, and a guiding rope is rolled up around the trench of the rolling device.

2. The device of claim 1, wherein the fixed device further comprises a fixed portion that is utilized to support and locate the improved rolling up curtain device in place.

3. The device of claim 1, wherein the driving device comprises a driving gear and a driving chain, the driving gear further comprises a plurality of gear slots, and the driving chain comprises a plurality of beads, the driving chain is hanged onto the driving gear, the driving gear and the driving shaft have a coincided central point in such that the driving shaft is positioned perpendicularly to a back surface of the driving gear.

4. The device of claim 1, wherein a driving section is formed on one end of the driving shaft, the driving section of the driving shaft is utilized to drive the resistant device and the rolling device.

5. The device of claim 4, wherein a trench opening formed inside the rolling device, a hole is formed on a top part of the trench opening, and a stop block is formed at a circumference of the trench opening, the trench is slipped onto the resistant device, the hole is slipped through the driving section of the driving shaft, wherein a shape of a cross-sectional area of the hole is correspondingly to a shape of a cross-sectional area of the driving section, and a rotating angle of the driving section inside the hole is less than 180 degrees.

6. The device of claim 5, wherein the resistant device comprises a sleeve and an anti-elastic unit, the sleeve further comprises a cavity, and a stop unit is formed respectively on each end of the anti-elastic unit, the sleeve is slipped onto the anti-elastic unit, and the two stop units are located within the cavity of the sleeve, the anti-elastic unit is then assembled onto the protruding portion of the fixed device, the trench opening is slipped onto the sleeve, wherein the slop block is positioned in between a gap of the two stop units of the anti-elastic unit, and a width size of the stop block is smaller than a width between the gap of two stop units of the anti-elastic unit.

7. The device of claim 1, wherein the improved rolling up curtain device further comprises a cover locating onto the fixed device.

8. The device of claim 1, wherein the device comprises at least one small slot formed on a top portion of a rolling disc of the rolling device.
